(19) United States
(12) Patent Application Publication
(10) Pub. No.: US 2026/0236552 A1
(43) Pub. Date: Aug. 13, 2026

(54) Optimal Control of Piecewise Affine (PWA) Systems Using Mixed-Integer Programming with Iterative Convex Hull Refinement

(71) Applicant: Mitsubishi Electric Research Laboratories, Inc., Cambridge, MA (US)

(72) Inventors: Arvind Raghunathan, Medford, MA (US); Prachi Shah, Atlanta, GA (US)

(73) Assignee: Mitsubishi Electric Research Laboratories, Inc., Cambridge, MA (US)

(21) Appl. No.: 19/053,063

(22) Filed: Feb. 13, 2025

(51) Int. Cl. G06F 17/11

(52) U.S. Cl. CPC G06F 17/11

(57) ABSTRACT

A control system and method for optimizing the operation of piecewise affine (PWA) systems by solving a mixed-integer programming (MIP) problem with iterative convex hull refinement are disclosed. The system balances computational efficiency and precision by solving a relaxed version of the MIP problem and iteratively strengthening it using convex hull constraints determined over subsequences of consecutive time steps. Violations in the relaxed solution are identified by comparing it against independently determined convex hull formulations, and refinement is achieved by introducing targeted cutting-plane inequalities. The refined relaxation is then re-solved to ensure compliance with system constraints while maintaining computational feasibility. This approach enables efficient control of PWA systems with discrete state transitions and continuous control inputs across a time horizon. The system is applicable to various domains, including robotic control, energy management, automotive systems, and industrial process optimization, where it improves decision-making efficiency while reducing computational overhead.

### TECHNICAL FIELD

The present disclosure relates to the field of control systems and optimization, specifically to methods for controlling piecewise affine (PWA) systems. It involves solving mixed-integer programming (MIP) problems to optimize the operation of systems characterized by discrete state transitions and continuous control dynamics. The disclosure is applicable to a variety of domains, including robotics, energy management, automotive systems, and industrial process control.

### BACKGROUND

Mixed-Integer Programming (MIP) problems are widely used in optimal control and decision-making for systems with both discrete and continuous dynamics. A particularly important class of systems, known as Piecewise Affine (PWA) systems, arises in a variety of domains, including robotics, automotive systems, energy management, and process control. PWA systems are characterized by distinct affine dynamics that govern their behavior in different regions of their state and input space. Controlling these systems requires solving optimization problems that manage transitions between regions while ensuring compliance with system constraints.

One significant challenge in controlling PWA systems lies in solving the MIP formulation of the optimal control within strict computational limits so as to implement the control action. The control process involves coupling discrete choices, such as selecting the active region of the system's state space or operational mode, with continuous control decisions that influence system trajectories. Solution of MIP relies on using Branch & Bound (BB) algorithm where in each node of the BB algorithm a continuous relaxation of the MIP is solved to obtain a lower bound on the MIP. A tight continuous relaxation of the MIP results in exploring fewer nodes in the BB algorithm to obtain a solution of the MIP. The tightest continuous relaxation is the convex hull formulation. If a convex hull of the feasible region of MIP is available, then the optimal objective value of the MIP can be obtained by solving a single convex continuous optimization problem which is vastly more computationally efficient. Typically, convex hull formulations have an exponential number of variables and constraints. The large size of the convex hull formulation renders it computationally intractable. Traditional methods for solving MIPs rely on simple continuous relaxations of the MIP or applying globally tight formulations like convex hulls. However, these approaches face significant limitations. Simplified relaxations often lead to long computational times, while globally tight formulations introduce additional variables and constraints, resulting in computational intractability, especially for large-scale systems or long-time horizons.

There is a need for an approach that integrates the precision of convex hull formulations with the computational efficiency of simpler relaxations. This approach must address violations in the relaxed solutions without incurring the overhead of a global convex hull computation, particularly for time-dependent systems where constraints and dynamics vary across time steps.

### SUMMARY

Some embodiments are based on the understanding that the convex hull formulation provides the strongest and tightest relaxation for mixed-integer programming (MIP) problems, particularly for Piecewise Affine (PWA) systems. By capturing the exact convex envelope of the feasible region, it minimizes the gap between relaxed and true integer-constrained solutions. However, applying the convex hull formulation globally across all time steps in time-dependent systems introduces additional variables and constraints that scale poorly with problem size, making the solution computationally intractable for systems with long time horizons, potentially spanning hundreds of time steps.

To address this challenge, the method applies the convex hull formulation independently to short subsequences of consecutive time steps (e.g., two or three steps) rather than across the entire time horizon. The relaxation is still determined for the entire time horizon, accounting for the temporal evolution of states and controls over hundreds of time steps. However, the convex hull formulations are only applied to localized subsequences, which significantly reduces computational complexity while preserving solution accuracy. Each convex hull formulation is determined independently for its respective subsequence of consecutive time steps, using only the constraints active at those steps and remaining independent of other time steps. This localized convex hull computation avoids the exponential complexity of computing a global convex hull over the entire time horizon.

The method detects violations by comparing the relaxed solution against the constraints of the convex hull formulations for each subsequence. If the solution satisfies all convex hull constraints across all subsequences, no further refinement is needed. However, if the solution violates a convex hull constraint for any subsequence, this indicates that the simpler relaxation has permitted an invalid solution. These violations serve as critical diagnostic signals for identifying where relaxation needs to be strengthened.

In response to detected violations, the relaxation is iteratively refined by introducing additional inequalities, referred to as cutting planes. These cuts exclude the invalid solutions from the relaxed feasible space without requiring a full redefinition of the problem or introducing unnecessary variables. The strengthened model is then re-solved to obtain a refined solution that better respects the true constraints of the problem. This iterative refinement process ensures computational efficiency by applying the convex hull formulation only where violations occur, maintaining scalability for large and complex systems.

By iteratively refining only the necessary subsequences, this approach balances the computational simplicity of the relaxed formulation with the precision of the convex hull constraints. The method progressively tightens the relaxation without incurring the computational burden of applying the convex hull globally. The result is a scalable and efficient method for improving MIP formulations in PWA systems, making it practical for applications in robotics, energy management, automotive control, and industrial process optimization.

In effect, this approach leverages the convex hull over a sequence of consecutive time steps as a localized tool for detecting violations in suboptimal relaxations. By comparing the solution with the convex hull constraints determined over a subsequence of consecutive time steps, invalid solutions are identified and excluded through targeted inequalities. This process tightens the relaxation incrementally, resolving the problem for a refined solution without incurring the computational burden of applying the convex hull globally. The result is a scalable and efficient method for improving MIP formulations in PWA systems, combining the computational simplicity of relaxed models with the precision of convex hulls.

Accordingly, one embodiment discloses a method for controlling a piecewise affine (PWA) system having discrete state transitions by solving a mixed-integer programming (MIP) problem that couples discrete choices of modes of operation the PWA system or regions of state space of the PWA system with continuous control decisions over a time horizon, comprising: solving a relaxation of the MIP problem that considers a temporal evolution of states and controls of the PWA system across a sequence of time steps in the time horizon to produce a solution defining a sequence of control commands transitioning a sequence of states of the PWA system within the time horizon; comparing the solution with a sequence of convex hull formulations determined for different subsequences of consecutive time steps, each of the convex hull formulations is determined for a subsequence of consecutive time steps with the time horizon independently from other convex hull formulations in the sequence of convex hull formulations over a sequence of consecutive time steps of the PWA system determined independently for each time step of different sequences of consecutive time steps in the time horizon, wherein each of the convex hull formulations captures the tightest feasible region of state space defined by convex hull constraints at a corresponding subsequence of the time steps; detecting violations in the solution of the relaxation of the MIP problem when by the solution over a subsequence of consecutive time steps at the time step violates the convex hull formulation for that subsequence of consecutive time steps; refining the relaxation of the MIP problem by adding inequalities that cut off the detected violations; resolving the refined relaxation to refine the solution; and controlling the PWA system with a control command determined based on the solution of the refined relaxation that does not violate the convex hull formulations.

Another embodiment discloses a control system for controlling a piecewise affine (PWA) system having discrete state transitions and continuous control dynamics, the control system comprising: a processor configured to execute instructions for solving a mixed-integer programming (MIP) problem that couples discrete mode selections of the PWA system with continuous control decisions over a time horizon; and a memory storing instructions that, when executed by the processor, cause the control system to: solve a relaxation of the MIP problem that considers a temporal evolution of states and controls of the PWA system across a sequence of time steps in the time horizon to generate a solution defining a sequence of control commands transitioning a sequence of states of the PWA system within the time horizon; compare the solution with a sequence of convex hull formulations determined for different subsequences of consecutive time steps, each of the convex hull formulations capturing the tightest feasible region of state space at a corresponding subsequence of the time steps; detect violations in the solution of the relaxation of the MIP problem when the solution over a subsequence of consecutive time steps violates the convex hull formulation for that subsequence; refine the relaxation of the MIP problem by adding inequalities that cut off the detected violations; resolve the refined relaxation to refine the solution; and generate a control command for operating the PWA system based on the solution of the refined relaxation that does not violate the convex hull formulations.

### BRIEF DESCRIPTION OF THE DRAWINGS

FIG. 1 shows a schematic representation of principles for solving the problem of optimal control for Piecewise Affine (PWA) systems employed by some embodiments.

FIG. 2 illustrates a schematic of the iterative strengthening of a weak relaxation of Mixed-Integer Programming (MIP) formulation by applying cutting planes derived from a stronger model according to some embodiments.

FIG. 3 shows a flow chart that outlines a method for controlling a piecewise affine (PWA) system with discrete state transitions by solving a mixed-integer programming (MIP) problem according to one embodiment.

FIG. 4 shows a schematic of an embodiment that specifies that the relaxation of the Mixed-Integer Programming (MIP) problem is a linear relaxation 410.

FIG. 5 shows a schematic of a method for implementing a refinement 340 where violations of the convex hull formulation for a sequence of consecutive time steps are addressed using a cut-generating linear program (CGLP) according to some embodiments.

FIG. 6 shows a schematic for steps of implementing CGLP using existing linear programming solvers according to some embodiments.

FIG. 7 shows a schematic of an example illustrating principles of stronger formulations employed by some embodiments.

FIG. 8 shows a pseudo-code of an algorithm 800 for solving linear program with cuts according to some embodiments.

FIG. 9 illustrates computing device that is representative of any system or collection of systems in which the various processes, programs, services, and scenarios disclosed herein may be implemented.

### DETAILED DESCRIPTION

### Overview of the Contribution to the Art

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

The contribution to the field of optimal control and mixed-integer programming (MIP) for Piecewise Affine (PWA) systems addresses a critical challenge in balancing computational feasibility and solution quality. PWA systems, characterized by discrete state transitions and continuous dynamics, are widely used in domains such as robotics, energy management, and automotive systems. Controlling these systems often requires solving MIP formulations, but conventional methods face a trade-off: simpler relaxations result in inefficient solutions, while tighter convex hull formulations become computationally intractable due to exponential complexity. The proposed work tackles this challenge by introducing a novel approach that iteratively refines simpler relaxations to achieve the precision of convex hull formulations without the associated computational burden.

A key realization underpinning this approach is that the convex hull provides the tightest relaxation of an MIP problem, offering a minimal gap between relaxed and true integer-constrained solutions. However, applying the convex hull globally across all time steps introduces an exponential growth in problem size, making it impractical for real-world applications. Instead, the embodiments recognize the potential of localizing the convex hull formulation to subsequences of consecutive time steps. This independence allows violations in simpler relaxations to be detected at specific time intervals without requiring a global computation, significantly reducing complexity.

Building on this insight, the proposed solution employs an iterative method to refine the relaxation of the MIP problem. Initially, a simpler relaxation is solved to provide an approximate solution. This solution is then compared against a convex hull formulation localized to subsequences of consecutive time steps. If violations are detected—indicating that the simpler relaxation has allowed invalid solutions—additional inequalities, known as cutting planes, are introduced to exclude these invalid solutions. By targeting only the violated constraints, this process avoids the need to redefine the entire problem or add unnecessary variables, maintaining computational efficiency.

The technical effect of this method is a substantial improvement in computational performance. The iterative refinement process tightens the relaxation incrementally, enabling the MIP solver to focus only on problematic regions of the solution space. This localized approach reduces the computational time required to solve the MIP while preserving the precision of the convex hull formulation. Furthermore, it ensures scalability, making it applicable to large-scale or real-time systems with long time horizons and complex dynamics.

The practical implications of this technical advancement are significant across various industries. In robotics, the method enables efficient control of systems requiring discrete transitions, such as humanoid balancing or contact-based manipulation tasks. In energy management, it optimizes the switching of energy sources and storage systems to enhance efficiency. Automotive applications benefit from improved control of powertrain configurations, resulting in better fuel efficiency and performance. Similarly, industrial process control systems can optimize machinery operations while ensuring compliance with safety constraints.

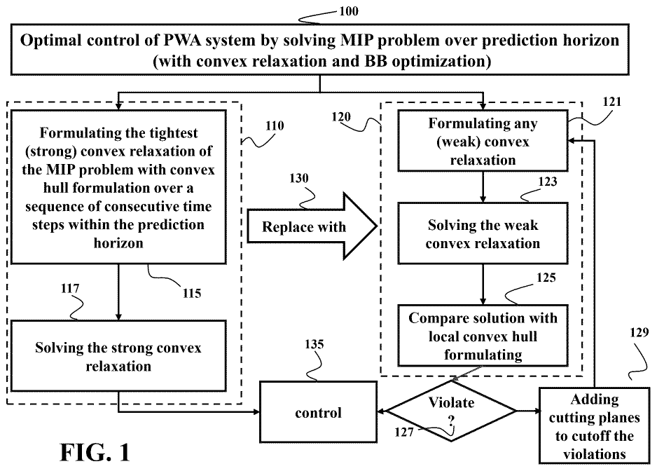

FIG. 1 shows a schematic representation of principles for solving the problem of optimal control for Piecewise Affine (PWA) systems (100) employed by some embodiments. The diagram illustrates two approaches: the strong relaxation method (110) and the iterative weak relaxation method (120). Both aim to determine the control commands (135) for the PWA system, but the iterative weak relaxation approach (120) offers significant computational advantages, making it a more efficient option for real-time and large-scale applications. Hence, some embodiments replace 130 strong relaxation 110 with iterative weak relaxation 120.

The strong relaxation approach (110) relies on a compiled convex hull formulation (115), which provides the tightest convex relaxation by capturing the smallest convex region containing all feasible solutions. Once this strong relaxation is established, it is solved (117) to produce precise control commands (135). While this method ensures high accuracy and avoids constraint violations, it requires substantial computational resources due to the global nature of the convex hull formulation, which becomes increasingly complex for systems with long prediction horizons or high-dimensional dynamics.

In contrast, the iterative weak relaxation approach (120) begins with formulating a weak convex relaxation (121). This initial relaxation simplifies the problem by using fewer constraints, making it computationally lightweight. The weak relaxation is solved (123) to generate preliminary solutions. These solutions are then compared (125) against a local, decoupled convex hull formulation, which is independently determined for a subsequence of consecutive time steps within the prediction horizon. This localized comparison (125) is where the computational advantage emerges, as the decoupled convex hulls avoid the exponential complexity of a global convex formulation.

The use of local convex hull formulations (125) determined independently for different time steps within a prediction horizon is more efficient and could be further optimized in embodiments where the convex hulls are precomputed offline and reused for online control. If the comparison (125) shows that the weak relaxation solutions violate the constraints, additional cutting planes are introduced (127). These cutting planes refine the weak formulation by excluding the invalid solutions. The updated weak formulation (121) is then resolved (123), iteratively improving the solution while maintaining computational efficiency. If no violations are detected during the comparison (125), the solutions obtained from solving the weak formulation (123) are used directly to generate control commands (135).

This iterative process—formulating a weak relaxation (121), solving it (123), comparing the results with local convex hulls (125), and adding cutting planes if necessary (127, 129)—ensures that the final solution adheres to system constraints. The approach balances simplicity and precision, targeting computational resources only where needed, and progressively refining the model to meet the control requirements.

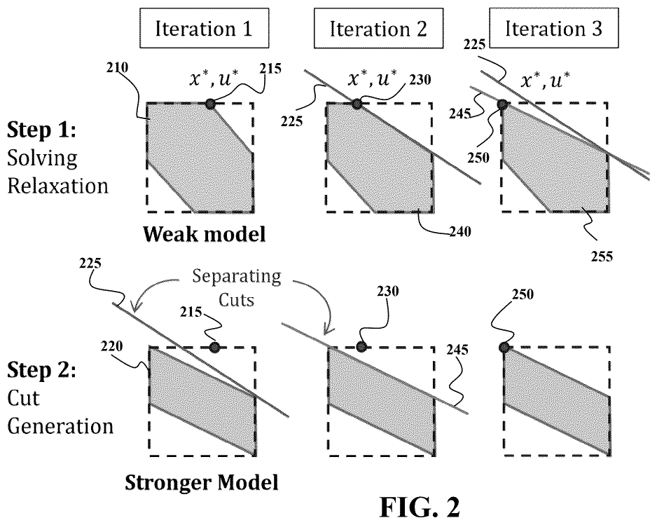

FIG. 2 illustrates a schematic of the iterative strengthening of a weak relaxation of Mixed-Integer Programming (MIP) formulation by applying cutting planes derived from a stronger model according to some embodiments. Each column in the figure represents an iteration comprising two steps: solving the relaxation of the constrained weak model and generating a new cut when a violation is detected. This systematic process aims to progressively reduce the gap between the weak model's feasible region and the convex hull of the strong model's solutions.

The region 210 represents the feasible region of the weak model's relaxation after applying previous cuts. This region is computationally simpler to solve but less precise compared to the strong model. The weak model's feasible region serves as the initial starting point for iterative refinement, capturing a relaxed approximation of the solution space while being efficient to compute.

In contrast, region 220 represents the feasible region of the strong model, defined as the convex hull of all feasible solutions for each of the time step. This region provides a tighter and more accurate representation of the problem. However, solving the strong model directly is computationally intensive, so the iterative approach uses this region as the benchmark. The gap between regions 210 and 220 highlights violations where solutions of the weak model fail to satisfy the constraints of the strong model.

When the weak model is solved, violations of the strong model's constraints are identified as solutions lying within region 210 but outside region 220. Such a violated solution is marked as 215, representing a point where the weak model fails to adhere to the strong model's constraints. These violations determine where the weak model requires additional refinement.

To address these violations, a cutting plane, denoted as 225, is generated and added to the weak model. This cutting plane is a constraint designed to exclude the violated solution while preserving the feasible solutions of the strong model. The introduction of this cut effectively tightens the weak model's feasible region, bringing it closer to that of the strong model. Cutting planes are crafted to enhance accuracy without excessive computational overhead. Notably, the weak relaxation can produce multiple solutions, but only the solutions that violate the constraints of the strong model are used to tighten weak relaxation to improve the efficiency.

The updated feasible region of the weak model after incorporating the cutting plane is labeled as 240. This refined region reflects the constrained relaxation of the weak model and serves as the starting point for the next iteration. The iterative process ensures that with each step, the gap between regions 240 and 220 narrows, gradually aligning the weak model with the strong model's feasible region.

The iterative solution of the constrained weak relaxation 240, continues to produce new solutions such as 230. If a new solution violates the strong model's constraints, another cutting plane 245 is added, and the process repeats for the updated constrained weak relaxation 255. This cycle continues until a solution 250 is found that satisfies both the constrained weak relaxation and the strong model, indicating convergence.

This iterative approach balances computational efficiency and solution accuracy. By progressively refining the weak model with targeted cutting planes, the method avoids the computational burden of directly solving the strong model while achieving a solution that adheres to its constraints. This strategy is particularly valuable for complex optimization problems requiring efficient and precise solutions over challenging feasible regions.

Referring back to FIG. 1, while both methods ultimately produce the same control commands (135), the iterative weak relaxation (120) is significantly more computationally efficient than the strong relaxation (110). Both the iterative weak relaxation (120) and the strong relaxation (110) can lead to the same or similar solutions that can be subsequently analyze with different techniques such as Branch & Bound (BB) algorithm, to produce the control commands used in a current time step to control PWA system. By leveraging localized, decoupled convex hull formulations and iterative refinement, the weak relaxation method avoids the exponential complexity of global convex hull computations, making it a practical and scalable solution for controlling PWA systems in various applications.

This technology not only bridges the gap between computational feasibility and precision but also introduces flexibility in its application. The framework allows practitioners to choose base MIP formulations tailored to specific needs and domains. By focusing on localized convex hull computations and refining relaxations only where violations occur, the approach provides a scalable and efficient solution for a wide range of PWA system control problems.

In effect, the proposed method advances the state of the art in MIP-based control of PWA systems by integrating the computational efficiency of simpler relaxations with the precision of convex hull formulations. Its localized and iterative refinement process ensures scalability and practicality, making it a valuable tool for addressing the challenges of real-world hybrid systems. This work paves the way for further enhancing MIP formulations, including applications in model predictive control and strategies for reusing computational results across iterative cycles.

### Exemplar Embodiments

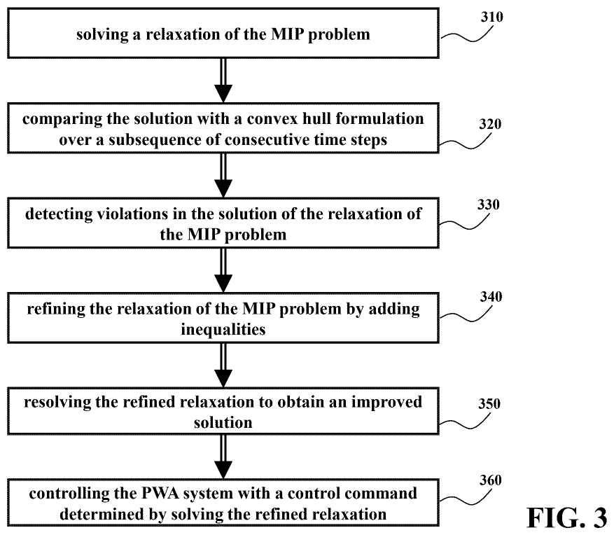

FIG. 3 shows a flow chart that outlines a method for controlling a piecewise affine (PWA) system with discrete state transitions by solving a mixed-integer programming (MIP) problem according to one embodiment. This approach integrates discrete mode selections of the PWA system's operational states or state-space regions with continuous control decisions over a given time horizon. The figure and its reference numbers align with the iterative process discussed earlier and the concepts detailed in the accompanying document, particularly the iterative strengthening of MIP formulations. In various embodiments, the MIP problem represents an optimal control problem for a PWA system, and the relaxation incorporates dynamics linking states and controls across consecutive time steps.

The process begins with 310, where a relaxation of the MIP problem is solved. This step considers the temporal evolution of the PWA system's states and control decisions over a sequence of time steps within the specified time horizon. The solution produced at this stage defines a sequence of control commands that guide the system through a series of state transitions across the time horizon. This relaxed formulation simplifies the problem by omitting some constraints, allowing for an efficient but less precise solution.

Following the relaxation, the solution is compared in 320 with a convex hull formulation defined independently for different subsequence of consecutive steps in the time horizon. This convex hull formulation captures the tightest feasible region of the state space, as constrained by the PWA system's dynamics and mode-specific boundaries. The comparison aims to identify discrepancies between the relaxed solution and the exact feasible region described by the convex hull.

In effect, the method applies the convex hull formulation independently to short subsequences of consecutive time steps (e.g., two or three steps) rather than across the entire time horizon. The relaxation used in solutionn 310 is still determined for the entire time horizon, accounting for the temporal evolution of states and controls over hundreds of time steps. However, the convex hull formulations for comparisons 320 are only applied to localized subsequences, which significantly reduces computational complexity while preserving solution accuracy. Each convex hull formulation is determined independently for its respective subsequence of consecutive time steps, using only the constraints active at those steps and remaining independent of other time steps. This localized convex hull computation avoids the exponential complexity of computing a global convex hull over the entire time horizon. In 330, violations are detected in the relaxed solution whenever it fails to satisfy the convex hull formulation for any subsequence of consecutive time steps. These violations indicate areas where the relaxed solution does not adhere to the constraints imposed by the PWA system's dynamics. Identifying these violations is critical for refining the model and ensuring adherence to the system's operational constraints.

The method detects violations by comparing the relaxed solution against the constraints of the convex hull formulations for each subsequence. If the solution satisfies all convex hull constraints across all subsequences, no further refinement is needed. However, if the solution violates a convex hull constraint for any subsequence, this indicates that the simpler relaxation has permitted an invalid solution. These violations serve as critical diagnostic signals for identifying where relaxation needs to be strengthened.

For a time horizon {0, . . . , T} set of subsequences of 1 consecutive time steps is given by

$$\{ \{ 0 , 1 \} , \{ 1 , 2 \} , … , \{ T - 1 , T \} \} .$$

The set of subsequences of 2 consecutive time steps is given by

$$\{ \{ 0 , 1 , 2 \} , \{ 1 , 2 , 3 \} , … , \{ T - 2 , T - 1 , T \} \} .$$

The set of subsequences of k consecutive time steps is given by

$$\{ \{ 0 , 1 … , k \} , \{ 1 , 2 , … , k + 1 \} , … , \{ T - k - 1 , … , T \} \} .$$

The next step, 340, refines the relaxation by adding inequalities to cut off the detected violations while preserving computational feasibility. These inequalities, or cutting planes, eliminate infeasible solutions that violate the convex hull constraints without excluding valid solutions. This refinement progressively tightens the relaxation, aligning it closer to the strong model.

In other words, in response to detected violations, the relaxation is iteratively refined by introducing additional inequalities, referred to as cutting planes. These cuts exclude the invalid solutions from the relaxed feasible space without requiring a full redefinition of the problem or introducing unnecessary variables. The strengthened model is then re-solved to obtain a refined solution that better respects the true constraints of the problem. This iterative refinement process ensures computational efficiency by applying the convex hull formulation only where violations occur, maintaining scalability for large and complex systems.

Once the relaxation is refined, 350 involves resolving the updated model to produce an improved solution. This solution satisfies the convex hull constraints and adheres to the PWA system's feasible region. The iterative refinement ensures that the relaxed model converges toward the strong model while maintaining computational efficiency.

Finally, in 360, the PWA system is controlled using the control command derived from solving the refined relaxation. This command ensures that the system operates within the independent convex hull formulations, respecting all constraints over the time horizon. By adhering to these constraints, the method achieves precise and efficient control of the PWA system.

This flow chart captures the iterative nature of solving and refining MIP formulations for PWA systems, as discussed earlier. By progressively strengthening the relaxed model, the method balances computational feasibility and accuracy, enabling the control of complex systems with discrete and continuous decision variables. This approach is particularly relevant for hybrid systems where both types of decisions are tightly coupled over time.

In some implementations, the method of FIG. 3 is further refined by specifying that the convex hull formulation over a sequence of consecutive time steps is determined independently for each time step. This independence is achieved by using the polyhedral constraints that define the system's dynamics and feasible state-space boundaries at specified subsequence of time steps disregarding the values a other time steps.

The polyhedral constraints represent the piecewise affine (PWA) system's mode-specific dynamics and operational boundaries. By ensuring that the convex hull constraints at a given subsequence of consecutive steps relies active at that subsequence of time step, the formulation avoids coupling across all time steps. This independence simplifies the convex hull generation, as each step can be treated as a standalone optimization problem rather than requiring the entire time horizon to be jointly constrained.

This characteristic of the method provides flexibility and computational efficiency. It ensures that the convex hull for each subsequence of consecutive time steps is as tight as possible while remaining computationally feasible. Moreover, it allows violations in the relaxed solution at a specific time step to be identified and resolved locally without propagating dependencies to other subsequences of consecutive time steps.

In some embodiments, the convex hull formulation over a subsequence of consecutive time steps for each time step is determined using the polyhedral constraints of the system at that time step and is independent of constraints at other time steps. By structuring the convex hull formulation in this manner, the method achieves a balance between precision and tractability, enabling scalable solutions for controlling PWA systems over extended time horizons.

To determine the convex hull formulation over a subsequence of consecutive time steps independently for each time step, one embodiment relies on the polyhedral constraints defining the PWA system's dynamics for each subsequence of consecutive time steps. These constraints ensure that the convex hull for each subsequence of consecutive time steps is as tight as possible while remaining computationally independent of other time steps.

At any given time step t, the polyhedral constraints of the PWA system in the i-th mode for i∈ [symbol] are defined as:

$${𝒫}_{t}^{i} = \{ ( {x}_{t} , {u}_{t} , {x}_{t + 1} ) \vert {F}_{t}^{i} {x}_{t} + {G}_{t}^{i} {u}_{t} + {H}_{t + 1}^{i} {x}_{t + 1} \leq {h}_{t}^{i} \} ,$$

where xₜ and uₜ are the state and control variables at time t, respectively and xₜ₊₁ is the state variable at time t+1. The matrices

$${F}_{t}^{i} , {G}_{t}^{i} , and {H}_{t + 1}^{i}$$

along with the vector

$${h}_{t}^{i} ,$$

describe the system's i-th mode-specific dynamics and feasible state-space boundaries at time t. Combining the constraints in the different modes i∈ [symbol] obtain the constraints defining the evolution of the PWA system at time t as

$${𝒫}_{t} = {⋃}_{i ∈ 𝒥} {𝒫}_{t}^{i} .$$

These polyhedral constraints for each mode i∈ [symbol] are inherently convex, meaning that

$${𝒫}_{t}^{i}$$

is itself a convex set, but the set [symbol] is not convex. Thus the convex hull of [symbol] is typically a bigger set that is:

$$conv ( {𝒫}_{t} ) ⊇ {𝒫}_{t} .$$

The independence of the convex hull formulation across time steps obtains from the fact that the constraints of conv( [symbol] ) is independent of conv( [symbol] ) or each t within the time horizon T:

$${𝒞}_{t} = conv ( {𝒫}_{t} ) , ∀ t ∈ [ 0 , T - 1 ] .$$

Here, [symbol] represents the feasible region of the convex hull for the PWA system at time t, determined exclusively by the polyhedral constraints at that time step. Note that [symbol] and [symbol] share variables, however the specification of convex hulls and checking for membership in convex hulls can be performed independently of other convex hulls. This representation ensures the decoupling of convex hulls across time steps.

This formulation enables violations in the relaxed solution to be identified locally at each time step. Suppose the relaxed solution of the MIP yields a sequence of states and controls

$${\{ ( {x}_{t}^{*} , {u}_{t}^{*} ) \}}_{t = 0}^{T - 1} .$$

For each t, if

$$( {x}_{t}^{*} , {u}_{t}^{*} , {x}_{t + 1}^{*} )$$

∉ [symbol] a violation is detected. These violations are addressed by generating cutting planes to exclude the infeasible solutions. Mathematically, the cutting planes can be expressed as:

$${α}_{t} {x}_{t} + {β}_{t} {u}_{t} + {γ}_{t + 1} {x}_{t + 1} \leq {b}_{t} ,$$

where αₜ, βₜ, γₜ₊₁ and bₜ are coefficients derived from the violated constraints at t. Adding these inequalities progressively tightens the relaxation while preserving the computational efficiency of the problem.

The method of this embodiment is structured as an iterative process to progressively refine the solution. It begins by solving the relaxation of the MIP using the current constraints. This initial solution provides a baseline that may not fully satisfy the tight convex hull constraints at each time step.

For each time step t, the solution

$$( {x}_{t}^{*} , {u}_{t}^{*} )$$

is evaluated against the convex hull constraints [symbol] . If violations are detected—where the solution does not lie within the feasible region defined by [symbol] —the method refines the relaxation by adding cutting planes that specifically address the violated constraints at those time steps. These cutting planes effectively exclude the infeasible solution while retaining the feasible ones.

Once the relaxation has been refined with these additional constraints, the problem is resolved to produce an improved solution. This process is repeated iteratively until no violations remain, ensuring that the final solution satisfies all convex hull constraints across the time horizon.

The independence of the convex hull formulation across time steps makes this method both efficient and scalable. Preprocessing can be utilized to precompute the convex hull constraints [symbol] for each time step, reducing computational overhead during optimization. Furthermore, since [symbol] is determined independently for each time step, computations can be parallelized, allowing for faster processing of large-scale problems. Additionally, in scenarios where the system's dynamics change, only the affected time steps need recalculating, preserving computational efficiency and enabling dynamic updates to the model. This structure makes the approach adaptable and robust for complex PWA systems.

This method ensures a balance between computational feasibility and solution accuracy, enabling the control of PWA systems with both discrete and continuous decision variables over extended time horizons. By iteratively refining the weak model through cutting planes, the approach achieves convergence to a solution that satisfies the PWA system's constraints without relying on globally coupled formulations. This aligns closely with the framework described in the attached document.

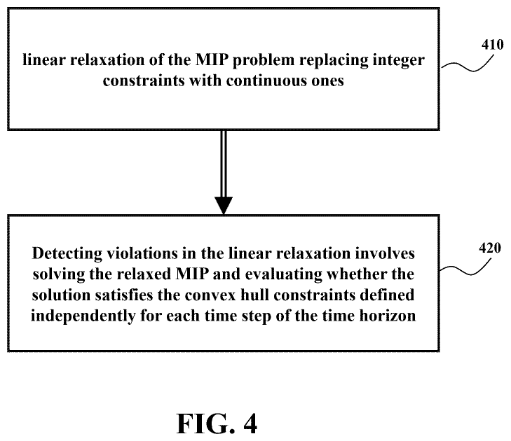

FIG. 4 shows a schematic of an embodiment that specifies that the relaxation of the Mixed-Integer Programming (MIP) problem is a linear relaxation 410. Linear relaxation simplifies the MIP by replacing integer constraints with continuous ones, significantly reducing computational complexity while retaining the overall structure of the optimization problem. This approach enables the efficient exploration of feasible solutions that approximate the original problem.

Detecting violations 420 in the linear relaxation involves solving the relaxed MIP and evaluating whether the solution satisfies the convex hull constraints defined independently for each time step of the time horizon. At each time step t, the PWA system's feasible region is represented as:

$${𝒫}_{t} = {⋃}_{i ∈ 𝒥} \{ ( {x}_{t} , {u}_{t} , {x}_{t + 1} ) \vert {F}_{t}^{i} {x}_{t} + {G}_{t}^{i} {u}_{t} + {H}_{t + 1}^{i} {x}_{t + 1} \leq {h}_{t}^{i} \} ,$$

where

$${F}_{t}^{i} , {G}_{t}^{i} , {H}_{t + 1}^{i}$$

and hₜ encode the system's mode-specific dynamics and operational boundaries at time t. The convex hull of this region, conv( [symbol] ), represents the tightest possible feasible region for the states xₜ, xₜ₊₁ and controls uₜ.

The convex hull constraints for each time step, [symbol] =conv( [symbol] ), are evaluated independently, ensuring no coupling with constraints from other time steps. This independence enables modularity and scalability. After solving the linear relaxation, the resulting solution

$$( {x}_{t}^{*} , {u}_{t}^{*} , {x}_{t + 1} )$$

is checked against [symbol] at each time step. A violation is detected if

$$( {x}_{t}^{*} , {u}_{t}^{*} , {x}_{t + 1} )$$

∉ [symbol] indicating that the solution lies outside the feasible region defined by the convex hull.

When violations are identified, cutting planes are introduced to eliminate the infeasible solutions while preserving valid ones. These cutting planes, expressed as:

$${α}_{t} {x}_{t} + {β}_{t} {u}_{t} + {γ}_{t + 1} {x}_{t + 1} \leq {b}_{t} ,$$

are added iteratively to refine the relaxation. Each refinement tightens the feasible region by incorporating new constraints that better approximate the original problem's feasible set.

This process is repeated iteratively: solving the linear relaxation, detecting violations, and refining the constraints until no violations remain. By progressively aligning the relaxed problem with the original MIP formulation, this method achieves convergence to a solution that satisfies all system constraints while maintaining computational efficiency.

Linear relaxations are computationally simpler to solve, enabling faster exploration of feasible solutions. The independence of [symbol] for each time step allows for parallel computation and efficient handling of large time horizons. By iteratively refining the relaxation, the method ensures that the final solution adheres to the tight constraints of the convex hulls for each time step. Changes to system dynamics require updates only to the affected time steps, preserving efficiency in dynamic environments.

By leveraging the computational simplicity of linear relaxations and focusing on convex hull violations, this embodiment balances efficiency and accuracy, making it a powerful tool for solving hybrid optimization problems such as those involving PWA systems.

Additionally or alternatively, some embodiments refining the relaxation with cutting-plane inequalities The method in these embodiments refines the relaxation of the MIP problem by introducing cutting-plane inequalities derived specifically from the convex hull constraints of the violated time steps. These inequalities are designed to exclude only the invalid solutions that violate the convex hull while preserving the feasibility of the overall MIP problem. This targeted refinement ensures that the feasible region remains as large as possible, maintaining computational efficiency and avoiding unnecessary constraints.

Practically, cutting planes are generated based on the convex hull representation of the feasible region at each violated time step. For a given violation at time t, the cutting-plane inequalities take the form:

$${α}_{t} {x}_{t} + {β}_{t} {u}_{t} + {γ}_{t + 1} {x}_{t + 1} \leq {b}_{t} ,$$

where αₜ, βₜ, γₜ₊₁ and bₜ are derived from the geometry of the convex hull constraints at time t. These inequalities are added iteratively to the relaxation, progressively improving its alignment with the strong MIP formulation.

In such a manner, the convex hull constraints serve as a diagnostic tool to guide the refinement process. Instead of applying cutting-plane constraints globally across all time steps, the method selectively focuses on the time steps where violations occur. This selective refinement reduces computational overhead by narrowing the scope of the adjustments and avoids introducing unnecessary constraints that could complicate the optimization.

To implement this, the solution to the relaxed MIP is evaluated independently against the convex hull constraints [symbol] for each time step t. Violations, where

$$( {x}_{t}^{*} , {u}_{t}^{*} , {x}_{t + 1}^{*} )$$

∉ [symbol] , trigger the refinement process. Time steps without violations are left unchanged, preserving their original constraints and reducing unnecessary computational effort.

To ensure the solution satisfies all convex hull constraints, the refined relaxation is resolved iteratively. After introducing cutting planes for the violated time steps, the linear relaxation of the MIP problem is solved again. The solution is re-evaluated against the convex hull constraints for all time steps, and further violations, if detected, trigger additional refinements.

This iterative process continues until no violations are detected at any time step. By converging on a solution that satisfies the convex hull constraints across all time steps, the method guarantees that the relaxation aligns closely with the feasible set of the original MIP problem. This iterative refinement ensures accuracy while maintaining computational feasibility throughout the optimization process.

Advantageously, these embodiments enhance the method's efficiency and scalability even further. By applying cutting-plane inequalities only where violations occur, the method minimizes computational complexity while maintaining the feasibility of the MIP problem. The use of convex hull constraints as a diagnostic tool enables precise, localized refinements, ensuring that adjustments are applied only to the affected time steps without impacting the rest of the model. These features, combined with the iterative resolution process, guarantee convergence to a solution that satisfies all system constraints. This modular and scalable approach is particularly effective for large-scale problems with many time steps, making it a robust and practical solution for optimizing complex systems like PWA systems.

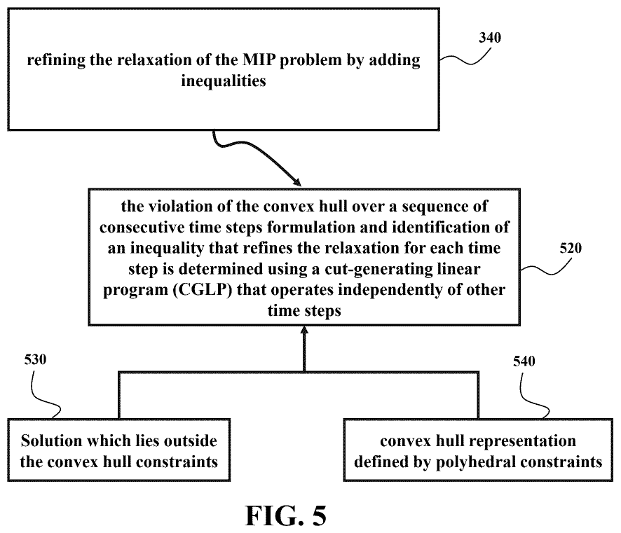

FIG. 5 shows a schematic of a method for implementing a refinement 340 where violations of the convex hull formulation for a sequence of consecutive time steps are addressed using a cut-generating linear program (CGLP) 520 according to some embodiments. This approach ensures that for each time step, violations are identified and resolved independently, maintaining modularity and computational efficiency.

The CGLP is a specialized linear program designed to generate cutting-plane inequalities that refine the relaxation of the MIP problem. For each violated time step t, the CGLP takes as input the violated solution

$$( {x}_{t}^{*} , {u}_{t}^{*} , {x}_{t + 1}^{*} )$$

530, which lies outside the convex hull constraints [symbol] ; and the convex hull representation [symbol] 540, defined by the polyhedral constraints of the PWA system at that time step.

The CGLP computes a cutting plane, represented as:

$${α}_{t} {x}_{t} + {β}_{t} {u}_{t} + {γ}_{t + 1} {x}_{t + 1} \leq {b}_{t} ,$$

where αₜ, βₜ, γₜ₊₁ and bₜ are coefficients derived from the geometry of the violated region. This inequality separates the violated solution

$$( {x}_{t}^{*} , {u}_{t}^{*} , {x}_{t + 1}^{*} )$$

from the feasible region, effectively excluding it from the relaxation while preserving all valid solutions within [symbol] .

The cut-generating linear program (CGLP) operates independently for each subsequence of consecutive time steps, ensuring that violations at one time step do not impact the refinement process for others. This independence allows the computation of cutting planes to be parallelized across time steps, which significantly reduces the overall computational time, especially for large-scale problems with extensive time horizons. Additionally, any updates to the constraints at a specific subsequence of consecutive time step remain localized and do not require modifications to the convex hull formulations or subsequences of consecutive time steps, thereby preserving the modularity of the approach.

Using the CGLP for generating cutting planes in MIP formulations for PWA systems provides several targeted advantages. It ensures precision by producing inequalities that directly address violations of the convex hull constraints at specific subsequence of consecutive time steps, effectively refining the relaxation without over-constraining the problem. The independence of the CGLP across time steps enhances scalability, allowing the method to efficiently handle PWA systems with long time horizons or a large number of discrete state transitions. Additionally, the flexibility of the approach enables localized updates; if system dynamics or operational constraints change, the CGLP can be re-applied only to the impacted time steps, avoiding the need for costly recalculations across the entire system. This combination of precision, scalability, and flexibility makes the method particularly well-suited for optimizing hybrid systems like PWA models.

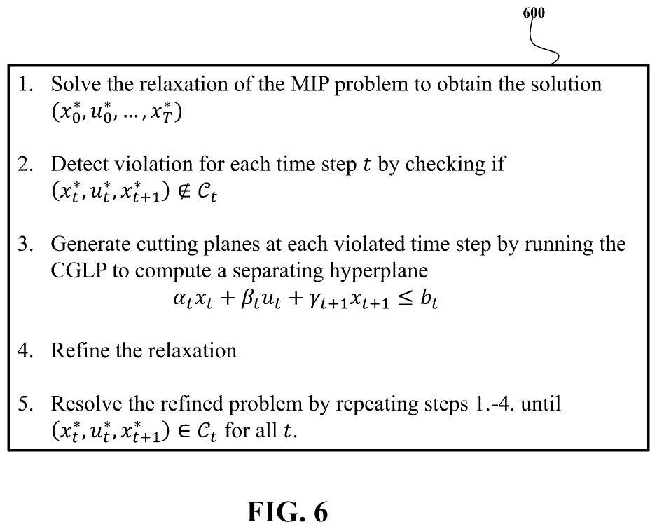

FIG. 6 shows a schematic 600 for steps of implementing CGLP using existing linear programming solvers according to some embodiments. The implementation begins by solving the initial relaxation of the MIP problem. This relaxation simplifies the problem by relaxing integer constraints into continuous ones, yielding a solution that may not yet satisfy the convex hull constraints for all time steps. At each iteration, the solution is evaluated against the convex hull representation for each subsequence of consecutive time steps. At each iteration, the embodiments (1) solve the MIP relaxation; (2) detect violations; (3) for each violated time step t, run the CGLP to generate a cutting plane; (4) refine the relaxation by adding the resulting inequality to the relaxation; and (5) re-solve the refined relaxation and repeat until no violations remain.

This iterative refinement ensures convergence to a solution that satisfies the convex hull constraints for all time steps, while maintaining computational efficiency and modularity. By leveraging the CGLP, the method achieves precise and scalable optimization, making it well-suited for complex PWA systems and other hybrid optimization problems.

### Exemplar Implementations

Some embodiments consider the optimal control of PieceWise Affine (PWA) systems with discrete state transitions, which is a key component in the model predictive control for hybrid systems with linear dynamics. This problem is modeled and solved as a Mixed-Integer Program (MIP). A significant challenge in developing effective MIP formulations arises from the trade-off between problem size and the strength of the linear relaxation. Some methods have attempted to strengthen the formulation by embedding convex hulls of a subset of constraints. However, the resulting formulations can be computationally intractable. This exemplar implementations introduce a hierarchy of disjunctive cuts that improve the linear relaxation bound by considering the convex hull of solutions corresponding to constraints aggregated across every k consecutive time steps for k∈{1, . . . , T}, where T is the length of the time horizon. Notably, the size of the cut-generation linear program for any k is independent of T.

### Notation

The notation [symbol] denotes the set of reals. The notation [T) will refer to the set {0, . . . , T−1} and [t₁, t₂] to refer to the set {t₁, . . . , t₂−1}. The convex hull of a set S is denoted by (S) and projₓ(S) represents the projection of set S onto the sub-space of x variables. The euclidean norm of a vector x is denoted by ∥x∥. For two vectors x∈ [symbol] , y∈ [symbol] and a matrix P∈ [symbol] , we denote by

$$P ( x , y ) := P [ \begin{matrix}x \\ y\end{matrix} ] .$$

For a set, the notation Sⁿ denotes the product space

$${\underbrace{\begin{matrix}S \times … \times S . & \end{matrix}}}_{ntimes}$$

The identity matrix is represented as I whose dimension should be clear from context.

### Optimal Control of PWA System

Consider a PWA system with xₜ∈ [symbol] , uₜ∈ [symbol] , and a set denoting the state of the system at time t, input at time t and the set of possible modes respectively. The domain of mode i∈ [symbol] is a polyhedron given by

$${𝒟}^{i} = \{ ( x , u ) \vert {F}^{i} x + {G}^{i} u \leq {h}^{i} \} . \qquad ( 1 )$$

Some embodiments assume that [symbol] includes bound constraints on the states and controls. The discrete time-invariant dynamics for all modes is expressed as

$${x}^{+} = {ψ}^{i} ( x , u ) := {A}^{i} x + {B}^{i} u + {c}^{i} , if ( x , u ) ∈ {𝒟}^{i} . \qquad ( 2 )$$

It is assumed that the system is well posed, that is, ψⁱ(x,u)=ψ^{j}(x,u) for all (x,u)∈ [symbol] , for all (i,j)∈ [symbol] . For simplicity in notation, the graph of a mode at time t, is defined as,

$$g r ( {ψ}_{t}^{i} ) := \{ ( {x}_{t} , {u}_{t} , {x}_{t + 1} ) \vert ( {x}_{t} , {u}_{t} ) ∈ {𝒟}^{i} , {x}_{t + 1} = {ψ}^{i} ( {x}_{t} , {u}_{t} ) \} \qquad ( 3 a )$$

$$= \{ ( {x}_{t} , {u}_{t} , {x}_{t + 1} ) \vert {P}^{i} ( {x}_{t} , {u}_{t} , {x}_{t + 1} ) \leq {q}^{i} \} \qquad ( 3 b )$$

where,

$${P}^{i} = [ \begin{matrix}{F}^{i} & {G}^{i} & 0 \\ {A}^{i} & {B}^{i} & - I \\ - {A}^{i} & - {B}^{i} & I\end{matrix} ] , {q}^{i} = [ \begin{matrix}{h}^{i} \\ - {c}^{i} \\ {c}^{i}\end{matrix} ] \qquad ( 4 )$$

The optimal control problem involves driving the system from an initial state \hat{x} to a terminal set [symbol] ={F_{T}x≤h_{T}} within T time steps while minimizing a cost that depends on the trajectory. We allow for the cost term associated with the terminal state X_{T} to be different as is typical in MPC formulations. The optimal control problem can be expressed as the disjunctive program,

$${min}_{x , u} {\sum }_{t ∈ [ T )} {‖ {Qx}_{t} ‖}^{2} + {\sum }_{t ∈ [ T )} {‖ {Ru}_{t} ‖}^{2} + {‖ {Px}_{T} ‖}^{2} \qquad ( 5 a )$$

$$s . t . {x}_{0} = \hat{x} \qquad ( 5 b )$$

$${F}_{T} {x}_{T} \leq {h}_{T} \qquad ( 5 c )$$

$$( {x}_{t} , {u}_{t} , {x}_{t + 1} ) ∈ {⋃}_{i ∈ 𝒥} g r ( {ψ}_{t}^{i} ) ∀ t ∈ [ T ) . \qquad ( 5 d )$$

The disjunctive formulations (5d) are not conducive to be handled directly by MIP solvers.

### MIP Formulations for PWA

There are several ways of converting the disjunctive program Eq.(5a) into a MIP. The key step is to reformulate (5d) using binary variables and this reformulation dictates the size and strength of the resulting relaxation. The reformulation can be accomplished if either the polyhedrons

$$g r ( {ψ}_{t}^{i} )$$

are bounded for all modes i∈ [symbol] or they have the same recession cone. Since the states and controls for the PWA system are usually bounded in practice, so are

$$g r ( {ψ}_{t}^{i} ) .$$

Some embodiments describe two different exemplar MIP formulations and then describe how one can obtain a convex-hull formulation for (5).

### Big-M Formulation

The first approach for reformulating (5) to a MIP is the Big-M formulation presented below.

$${min}_{x , u , z} {\sum }_{t ∈ [ T )} {‖ {Qx}_{t} ‖}^{2} + {\sum }_{t ∈ [ T )} {‖ {Ru}_{t} ‖}^{2} + {‖ {Px}_{T} ‖}^{2} \qquad ( 6 a )$$

$$s . t . {x}_{0} = \hat{x} , \qquad ( 6 b )$$

$${F}_{T} {x}_{T} \leq {h}_{T} , \qquad ( 6 c )$$

$${P}^{i} ( {x}_{t} , {u}_{t} , {x}_{t + 1} ) \leq {q}^{i} + {\sum }_{j \neq i} {M}_{ij} {z}_{j}^{t} , ∀ i , t ∈ 𝒥 \times [ T ) \qquad ( 6 d )$$

$${\sum }_{i ∈ 𝒥} {z}_{t}^{i} = 1 , ∀ t ∈ [ T ) \qquad ( 6 e )$$

$${z}_{t}^{i} ∈ \{ 0 , 1 \} , ∀ i , t ∈ 𝒥 \times [ T ) . \qquad ( 6 f )$$

where Mᵢⱼ are parameters satisfying,

$${M}_{ij} \geq max \{ {P}^{i} ( {x}_{t} , {u}_{t} , {x}_{t + 1} ) - {q}^{i} \vert ( {x}_{t} , {u}_{t} , {x}_{t + 1} ) ∈ g r ( {ψ}_{t}^{i} ) \}$$

An advantage of this approach is that it needs fewer additional variables and results in smaller models. However, a drawback of this approach is that the Big-M formulation is not tight, that is

$$conv ( {⋃}_{i ∈} g r ( {ψ}_{t}^{i} ) ) ⊆ {proj}_{( {x}_{t} , {u}_{t} , {x}_{t + 1} )} {S}_{BigM}$$

where S_{BigM} is the feasible regions of the linear relaxations of the Big-M model. It needs careful selection of the parameters Mᵢⱼ, possibly by solving auxiliary linear programs, and selecting arbitrarily large values may result in very weak formulations.

### Convex Hull-1 (CH-1) Formulation

The second approach exactly models

$$conv ( {⋃}_{i ∈} g r ( {ψ}_{t}^{i} ) )$$

at each time step and is therefore called the Convex Hull-1 (CH-1) model where the 1 indicates that we have the convex hull for a single time step. In this case, the subsequence of consecutive time steps is length l. A disadvantage of this approach is that it creates auxiliary state and input variables for each mode at every time step leading to a much larger model. Its MIP formulation is given by,

$$min {\sum }_{t ∈ [ T )} {‖ {Qx}_{t} ‖}^{2} + {\sum }_{t ∈ [ T )} {‖ {Ru}_{t} ‖}^{2} + {‖ {Px}_{T} ‖}^{2} \qquad ( 7 a )$$

$$s . t . {x}_{0} = \hat{x} , \qquad ( 7 b )$$

$${F}_{T} {x}_{T} \leq {h}_{T} , \qquad ( 7 c )$$

$${x}_{t} = {\sum }_{i ∈ I} {x}_{t}^{i} , ∀ t ∈ [ T ) \qquad ( 7 d )$$

$${u}_{t} = {\sum }_{i ∈ I} {u}_{t}^{i} , ∀ t ∈ [ T ) \qquad ( 7 e )$$

$${F}^{i} {x}_{t}^{i} + {G}^{i} {u}_{t}^{i} \leq {h}^{i} {z}_{t}^{i} , ∀ i , t ∈ 𝒥 \times [ T ) \qquad ( 7 f )$$

$${x}_{t + 1} = {\sum }_{i ∈ I} ( {A}^{i} {x}_{t}^{i} + {B}^{i} {u}_{t}^{i} + {c}^{i} {z}_{t}^{i} ) , ∀ t ∈ [ T ) \qquad ( 7 g )$$

$${\sum }_{i ∈ I} {z}_{t}^{i} = 1 , ∀ t ∈ [ T ) \qquad ( 7 h )$$

$${z}_{t}^{i} ∈ \{ 0 , 1 \} , ∀ i , t ∈ 𝒥 \times [ T ) \qquad ( 7 i )$$

This results in tight a formulation for the constraint at each time step, that is,

$$conv ( {⋃}_{i ∈} g r ( {ψ}_{t}^{i} ) ) = {proj}_{( {x}_{t} , {u}_{t} , {x}_{t + 1} )} {S}_{CH - 1} \qquad ( 8 )$$

where S_{CH-1} denotes the feasible regions of the linear relaxations of the above model.

### Stronger Formulations

It is possible to model constraints for each time step t separately. In general, for any sets S₁, S₂

$$( {S}_{1} ) ⋂ ( {S}_{2} ) ⊇ ( {S}_{1} ⋂ {S}_{2} ) \qquad ( 9 )$$

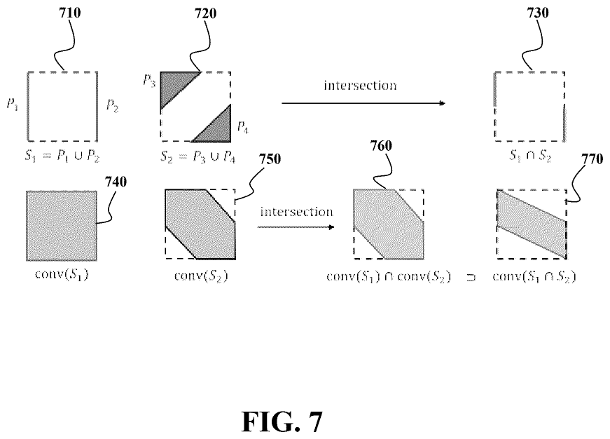

FIG. 7 shows a schematic of an example illustrating principles of stronger formulations employed by some embodiments. As depicted, the convex-hull of intersection of sets is in general strictly tighter than the intersection of the convex-hulls of the sets.

The sets S₁, S₂ are defined as the union of two disjoint sets P₁, P₂ 710 and the sets P₃, P₄ 720 respectively. The convex hulls of S₁, S₂ are shown regions 740 and 750 respectively. The intersection of the two convex-hulls is shown as the larger region 760. The intersection of the two sets S₁, S₂ is also a union of two disjoint sets 730 and the convex-hull of the intersection is a smaller region 770.

Applying this to PWA systems with t:

$${S}_{t} := {⋃}_{i ∈} g r ( {ψ}_{t}^{i} )$$

implies,

$$( {⋃}_{i ∈ 𝒥} g r ( {ψ}_{t}^{i} ) ) ⋂ ( {⋃}_{j ∈ 𝒥} g r ( {ψ}_{t + 1}^{j} ) ) \qquad ( 10 a )$$

$$⊇ ( ( {⋃}_{i ∈ 𝒥} g r ( {ψ}_{t}^{i} ) ) ⋂ ( {⋃}_{j ∈ 𝒥} g r ( {ψ}_{t + 1}^{j} ) ) ) \qquad ( 10 b )$$

$$= {⋃}_{( i , j ) ∈ {𝒥}^{2}} g r ( {ψ}_{t}^{i} ) ⋂ g r ( {ψ}_{t + 1}^{j} ) ) \qquad ( 10 c )$$

This step is used by some implementations to obtain stronger MIP formulations for disjunctive programs. For the optimal control problem, this step can be recursively applied k≤T times to obtain the relation,

$${⋂}_{t ∈ [ {t}^{′} , {t}^{′} + k ]} ( {⋃}_{i ∈ 𝒥} g r ( {ψ}_{t}^{i} ) ) \qquad ( 11 a )$$

$$⊇ ( {⋂}_{t ∈ [ {t}^{′} , {t}^{′} + k ]} ( {⋃}_{i ∈ 𝒥} g r ( {ψ}_{t}^{i} ) ) ) \qquad ( 11 b )$$

$$= ( {⋃}_{\{ {i}_{{t}^{′} , … ,} {i}_{{i}^{′} + k - 1} \} ∈ {𝒥}^{k}} ( {⋂}_{t ∈ [ {t}^{′} , {t}^{′} + k ]} g r ( {ψ}_{t}^{{i}_{t}} ) ) ) \qquad ( 11 c )$$

$$= ( {⋃}_{m ∈ {𝒥}^{k}} ( {⋂}_{j ∈ [ k ]} g r ( {ψ}_{{t}^{′} + j}^{{m}_{j}} ) ) ) . \qquad ( 11 d )$$

where (11b) is obtained by recursively applying the basic step and in (11c) we have swapped the union and intersection by utilizing the associative and distributive property. Note that in (11c) the union is taken over all possible k-length mode sequences of the PWA. The expression (lid) is a concise representation of (11c), where m refers to a specific k-length mode sequence for the PWA and mⱼ refers to the mode of the PWA at the j-th time step in the sequence which happens to occur at time t′+j. In other words, even stronger formulations can be obtained by convexifying disjunction over all possible mode sequences of length k and replacing the constraints Eq.(5d) by the following, for all t∈[T−k],

$$( {x}_{t} , {u}_{t} , … , {x}_{t + k - 1} , {u}_{t + k - 1} , {x}_{t + k} ) ∈ {⋃}_{m ∈ {𝒥}^{k}} ( {⋂}_{j ∈ [ k ]} g r ( {ψ}_{t + j}^{{m}_{j}} ) ) . \qquad ( 12 )$$

Some embodiments refer to the resulting MIP formulation modelling the exact convex hull of the above disjunctions as the CH-k model. In Eq (12) is represented the convex hull for k-length subsequences of consecutive time steps. With k=T, this approach yields the true convex hull of the set of constraints in (5d). Other constraints in the formulation such as the initial and terminal conditions can also be similarly leveraged to obtain stronger formulations by including Sᵢₙᵢₜ={x₀|x₀=\hat{x}} and Sₜₑᵣₘ={x_{T}|F_{T}x_{T}≤h_{T}} in the conjunction of the basic step.

However, the model size increases exponentially with k as the number of disjunctions in (12) is [symbol] and can quickly get intractable for even small problems. To overcome this challenge, the embodiments apply disjunctive cuts that result in the same root node bound which we describe next.

### Disjunctive Cuts-Based Strengthening

Some embodiments use the following approach for strengthening MIP models. The method starts with a traditional MIP formulation such as (6) or (7) and henceforth, refer to it as the base model. The algorithm for strengthening iterates through two key steps. First, the linear relaxation of the base model is solved. Next, constraints valid for the stronger model but violated by this solution are identified and added to the base model. These are known as separating cuts because they separate the relaxation solution from the feasible space of the stronger model. The base model is then re-solved and this process is repeated until the relaxation solution lies within the feasible space of the stronger model, and no more separating cuts can be identified.

The constraint modeled for the subsequences of two consecutive time steps is of the form,

$$( {x}_{t} , {u}_{t} , {x}_{t + 1} , {u}_{t + 1} , {x}_{t + 2} ) ∈ {⋃}_{( i , j ) ∈ {𝒥}^{2}} ( gr ( {ψ}_{t}^{i} ) ⋂ gr ( {ψ}_{t + 1}^{j} ) ) \qquad ( 13 )$$

In this case, the disjunct corresponding to (i,j) is expressed with the following constraints,

$${F}^{i} {x}_{t} + {G}^{i} {u}_{t} \leq {h}^{i} \qquad ( 14 a )$$

$${A}^{i} {x}_{t} + {B}^{i} {u}_{t} - {Ix}_{t + 1} = - {c}^{i} \qquad ( 14 b )$$

$${F}^{j} {x}_{t + 1} + {G}^{j} {u}_{t + 1} \leq {h}^{j} \qquad ( 14 c )$$

$${A}^{j} {x}_{t + 1} + {B}^{j} {u}_{t + 1} - {Ix}_{t + 2} = - {c}^{j} \qquad ( 14 d )$$

Let the matrix representation of these constraints be

$${P}^{ij} ( {x}_{t} , {u}_{t} , {x}_{t + 1} , {u}_{t + 1} , {x}_{t + 2} ) \leq {q}^{ij} ,$$

for,

$${P}^{ij} = [ \begin{matrix}{F}^{i} & {G}^{i} & & & \\ {A}^{i} & {B}^{i} & - I & & \\ - {A}^{i} & - {B}^{i} & I & & \\ & & {F}^{j} & {G}^{j} & \\ & & {A}^{j} & {B}^{j} & - I \\ & & - {A}^{j} & - {B}^{j} & I\end{matrix} ] , {q}^{ij} = [ \begin{matrix}{h}^{i} \\ - {c}^{i} \\ {c}^{i} \\ {h}^{j} \\ - {c}^{j} \\ {c}^{j}\end{matrix} ] \qquad ( 15 )$$

Let [symbol] be the set of mode pairs (i,j) such that the linear system in (1) is feasible.

Suppose the linear relaxation solution of the base model is (x*,u*). If (x*,u*) does not satisfy (13) for some t, then separating cuts can be obtained by solving the following cut-generating linear program (CGLP),

$${d}^{*} = {max}_{α , β , {λ}^{ij}} α ( {x}_{t}^{*} , {u}_{t}^{*} , {x}_{t + 1}^{*} , {u}_{t + 1}^{*} , {x}_{t + 2}^{*} ) - β \qquad ( 16 a )$$

$$s . t . α = {( {P}^{ij} )}^{T} {λ}^{ij} ∀ ( i , j ) ∈ ℱ \qquad ( 16 b )$$

$$β \geq {( {q}^{ij} )}^{T} {λ}^{ij} ∀ ( i , j ) ∈ ℱ \qquad ( 16 c )$$

$${λ}^{ij} \geq 0 ∀ ( i , j ) ∈ ℱ \qquad ( 16 d )$$

$$- 1 \leq α \leq 1 \qquad ( 16 e )$$

where λ^{ij} are vectors of the same dimension as q^{ij}. Let (α*,β*) be the values of the variables (α,β) in the optimal solution. Then, the following is a valid separating cut if d*>0,

$${α}^{*} ( {x}_{t} , {u}_{t} , {x}_{t + 1} , {u}_{t + 1} , {x}_{t + 2} ) \leq {β}^{*} \qquad ( 17 )$$

Here the (16e) is a normalization constraint applied to truncate the feasible cone. Without this constraint, feasibility is maintained under scaling of all variables by a non-negative constant and the CGLP is unbounded whenever d*>0. Several other normalization constraints have been used by different implementations. The choice of normalization greatly influences the quality of cuts generated. Some embodiments choose this normalization as it led to a quicker solution of the CGLP for the PWA instances considered in the computational section while generating cuts of comparable strength to the alternatives. The objective value of the CGLP is positive if and only if (1) is violated.

The cuts identified by the CGLP are applied iteratively till the linear relaxation yields a solution that satisfies (1) at all t. The root node bound is therefore equal to the CH-2 formulation. The overall approach is described in Algorithm 1. Here the depth of cut is the Euclidean distance of the generated constraint from the point being separated and δ>0 is used as a tolerance to identify separating cuts. Moreover, T_{cuts} can be chosen as a subset of the time steps to provide flexibility within the algorithm.

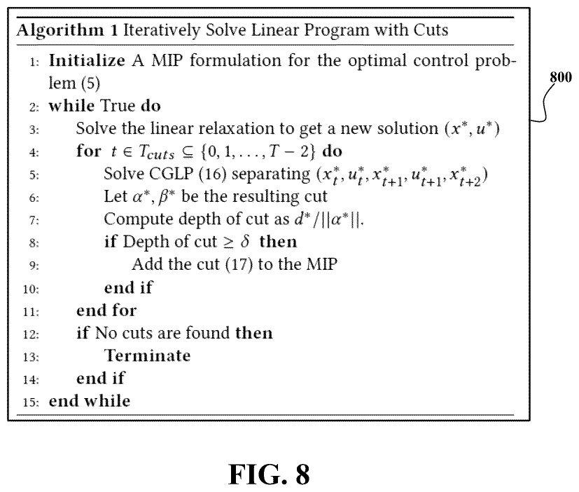

FIG. 8 shows a pseudo-code of an algorithm 800 for solving liner program with cuts according to some embodiments. Here the depth of cut is the Euclidean distance of the generated constraint from the point being separated and δ>0 is used as a tolerance to identify separating cuts. Moreover, T_{cuts} can be chosen as a subset of the time steps to provide flexibility within the algorithm.

A MIP formulation for the optimal control problem

```
do
Solve the linear relaxation to get a new solution (x*, u*)
for t ∈ T_{cuts} ⊆ {0, 1, . . . , T − 2}.
    $Next , solve CGLP ( 1 ) separating ( {x}_{t}^{*} , {u}_{t}^{*} , {x}_{t + 1}^{*} , {u}_{t + 1}^{*} , {x}_{t + 2}^{*} )$
    Let α*, β* be the resulting cut, then compute depth of cut as
    d*/∥α*∥.
    if Depth of cut ≥ δ
Add the cut (12) to the MIP
    end if
end for
while Cuts are found
```

To generate stronger cuts some implementations also include the initial and terminal condition constraints when separating the solution for t=0 and t=T−2 respectively. To include initial conditions, the matrices P^{ij} and q^{ij} are modified as follows,

$${P}_{init}^{i , j} = [ \begin{matrix}{P}^{ij} \\ [ \begin{matrix}I & 0 & 0 & 0 & 0 \\ - I & 0 & 0 & 0 & 0\end{matrix} ]\end{matrix} ] , {q}_{init}^{ij} = [ \begin{matrix}{q}^{ij} \\ \hat{x} \\ - \hat{x}\end{matrix} ] , \qquad ( 18 )$$

Similarly, to include terminal condition constraints, the following matrices are used,

$${P}_{term}^{i , j} = [ \begin{matrix}{P}^{ij} \\ [ \begin{matrix}0 & 0 & 0 & 0 & {F}_{T}\end{matrix} ]\end{matrix} ] , {q}_{term}^{ij} = [ \begin{matrix} & {q}^{ij} \\ {h}_{T} & \end{matrix} ] , \qquad ( 19 )$$

The CGLP in (16) is then solved using the modified matrices.

Generalizing to k-Step Aggregations

To extend this approach and generate cuts for the constraints (12), one embodiment models disjunct corresponding to a sequence of k modes. Let m∈ [symbol] be such a 0-indexed sequence. The corresponding disjunct in (12) is expressed with the following constraints,

$${F}^{{m}_{i}} {x}_{t + i} + {G}^{{m}_{i}} {u}_{t + i} \leq {h}^{{m}_{i}} for all i ∈ [ k ] \qquad ( 20 a )$$

$${A}^{{m}_{i}} {x}_{t + i} + {B}^{{m}_{i}} {u}_{t + i} - {Ix}_{t + i + 1} = - {c}^{{m}_{i}} for all i ∈ [ k ] \qquad ( 20 b )$$

for t∈[T−k]. The CGLP is then formulated using P^{m} and q^{m}, the matrix and vector representation of the above constraints. In this case, the convex hull formulation is considered for subsequences with k consecutive time steps.

For the time-invariant PWA system that we consider, the separation at all time steps can be achieved by the same CGLP model that depends only on k and is independent of the length of the time horizon. Therefore, our approach doesn't need to generate the stronger extended model for the entire time range and scales well compared to the corresponding CH-k MIP formulation. This can be advantageous for higher values of k where the model generation can be time-consuming. Moreover, this approach only refines the feasible region that is relevant to the objective function.

Since the embodiments apply cuts to any k-step interval, this framework can yield stronger bounds. At the same time, through the design of T_{cuts} our approach also allows flexibility in strengthening a subset of intervals that may be predicted to be important and avoiding solving CGLP for time steps that are less likely to affect the optimal solution of the relaxation.

This approach can be repeated at every node in the search tree. In which case, bounds at each node in the tree will be the same bound as CH-k formulation. However, there is a trade-off between strengthening the bound at each node and the overall time for solving the MIP.

### Exemplar Solutions

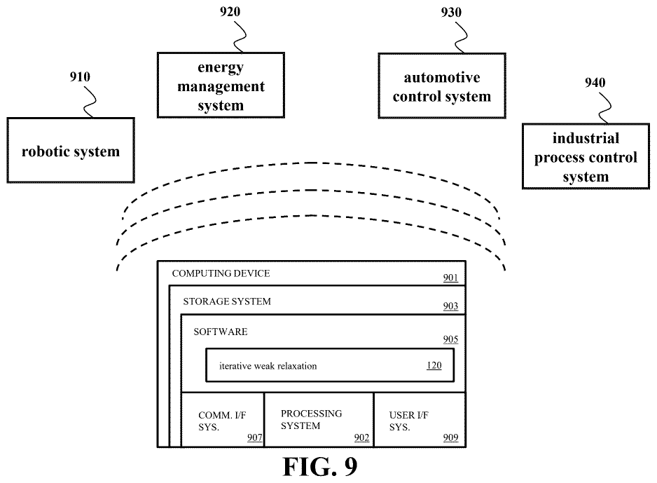

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes and implements principles of iterative weak relaxation approach (120) described in various exemplar embodiments. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, digital signal processors, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (iterative weak relaxation 120) may be implemented in program instructions and among other functions may, when executed by processing system 902, direct processing system 902 to operate as described with respect to the various operational scenarios, sequences, frameworks, and processes illustrated and/or discussed herein. For example, software 905 may include program instructions for implementing the sampling, training, and/or rendering processes described herein, as well as the probabilistic guided sampling discussed herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to perform computer vision processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems, may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The computing device shown in FIG. 9 is capable of controlling a variety of exemplar systems by leveraging the principles of Piecewise Affine (PWA) systems and iterative weak relaxation techniques. These principles demonstrate the adaptability of the approach for managing complex hybrid systems that involve both discrete transitions and continuous variables. Exemplar systems that can be effectively controlled by the computing device 901, employing iterative weak relaxation 120, include robotic system 910, energy management system 920, automotive control system 930, and industrial process control system 940.

### Application of Iterative Weak Relaxation in Robotic Systems

Robotic systems 910, with their hybrid dynamics, operate through discrete mode transitions and continuous control inputs to perform tasks such as gripping, manipulating, and free motion. These systems transition between operational modes such as free motion (e.g., arm movement through space), contact tasks (e.g., gripping an object), and manipulation tasks (e.g., assembling components). Each mode is governed by specific dynamics that the controller must optimize for precise and efficient operation. For example, during a gripping operation, contact forces must be managed to prevent object slippage, while in free motion, the trajectory must be optimized to avoid unnecessary energy expenditure and achieve smooth operation.

The hybrid nature of robotic systems poses challenges in coordinating discrete transitions (e.g., moving from free motion to gripping) with continuous control variables such as joint torques, end-effector velocities, and forces. These variables are subject to physical constraints, including joint torque limits, kinematic boundaries, and collision avoidance requirements. A robotic arm, for instance, must manage its torque inputs Tt, velocity vt, and position xₜ during transitions to ensure compliance with mechanical and operational constraints. These dynamics can be modeled within a Piecewise Affine (PWA) system framework.

In the PWA system, each mode m corresponds to a set of linear constraints that define its operational region. The system dynamics are represented as:

$${x}_{t + 1} = {A}_{m} {x}_{t} + {B}_{m} {u}_{t} + {d}_{m} ,$$

where xₜ is the state vector (e.g., joint angles and velocities), uₜ is the control input vector (e.g., applied torques or forces), and Aₘ, Bₘ, dₘ define the system's mode-specific dynamics. The constraints for each mode are expressed as:

$${A}_{m} {x}_{t} + {B}_{m} {u}_{t} \leq {c}_{m} ,$$

where cₘ represents physical limits, such as maximum torque or force constraints. These constraints define a polyhedral region [symbol] within which the system must operate during mode m.

The iterative weak relaxation method refines these constraints to improve the feasibility and precision of control decisions. Initially, a relaxed version of the Mixed-Integer Programming (MIP) problem is solved, allowing discrete transitions to be approximated as continuous variables. For instance, a gripping task might initially allow the robot to exceed allowable contact forces due to weak relaxation of the constraints. This relaxed solution is evaluated against the convex hull [symbol] of feasible states and inputs:

$${𝒞}_{t} = \{ ( {x}_{t} , {u}_{t} ) \vert {A}_{m} {x}_{t} + {B}_{m} {u}_{t} \leq {c}_{m} , ∀ m ∈ ℳ \} .$$

If the solution (xₜ,uₜ) violates these physical limits, corrective measures are introduced.

To refine the solution, cutting planes are generated that represent additional constraints based on the identified violations. These cuts, expressed as:

$${a}_{t}^{⊤} {x}_{t} + {b}_{t}^{⊤} {u}_{t} \leq {d}_{t} ,$$

exclude infeasible solutions while preserving the feasible space defined by the robot's physical capabilities. For example, if the initial solution allows a joint torque τₜ to exceed its limit, the cut ensures future solutions respect this boundary, thereby tightening the relaxation iteratively.

This iterative refinement ensures precise mode transitions and efficient motion planning. For a pick-and-place operation, the method optimizes the gripping force fₜ during contact tasks to prevent slippage and minimizes energy consumption Eₜ during free motion by optimizing the trajectory:

$${E}_{t} = {\int }_{0}^{T} {‖ {u}_{t} ‖}^{2} d t .$$

By progressively refining the feasible region, the method ensures that control inputs uₜ, such as joint torques and velocities, achieve the desired task objectives while adhering to physical constraints.

The localized application of convex hull formulations further enhances computational efficiency. Instead of applying a global convex hull computation, the method focuses on time steps where violations are detected, such as transitions between free motion and contact. This reduces the computational burden while maintaining precision. For example, during an assembly task, the method ensures that contact forces fₜ remain within the limits of the gripper's capabilities during object placement, avoiding damage or instability.

In effect, the iterative weak relaxation method connects the mathematical optimization of PWA systems to the physical quantities governing robotic systems. By iteratively refining the MIP formulation, the method ensures that discrete transitions, such as mode changes, and continuous variables, such as forces and torques, are optimized within realistic constraints. This approach not only enhances precision in robotic control but also reduces computational overhead, enabling scalability and adaptability for complex hybrid tasks in real-world robotic systems.

### Energy Management Systems

Some embodiments control energy management systems 920, where the PWA system represents discrete switching of energy sources or storage systems (e.g., solar panels, batteries, or generators) and continuous control of energy flow. The MIP problem optimizes energy consumption and operational efficiency over the time horizon, balancing energy demand with resource availability.

The system dynamics are expressed as:

$${x}_{t + 1} = {A}_{m} {x}_{t} + {B}_{m} {u}_{t} + {d}_{m} ,$$

where xₜ represents the system state (e.g., battery charge levels or power outputs), and uₜ represents control inputs (e.g., energy dispatch rates). Constraints such as power capacity limits or storage bounds are defined by:

$${A}_{m} {x}_{t} + {B}_{m} {u}_{t} \leq {c}_{m} .$$

Iterative weak relaxation ensures efficient solutions by refining relaxations for discrete switching decisions and continuous energy flows. For example, cutting planes such as:

$${a}_{t}^{⊤} {x}_{t} + {b}_{t}^{⊤} {u}_{t} \leq {d}_{t} ,$$

are added to exclude infeasible switching schedules or overloading scenarios. This refinement process guarantees that the energy system operates within its physical limits, optimizing energy efficiency while maintaining reliability.

### Automotive Control Systems

Some embodiments are integrated into automotive control systems 930 where the PWA framework represents discrete decisions such as gear shifts, drive modes (e.g., eco or sport), or powertrain configurations. These discrete decisions are integrated with continuous control variables like throttle, braking, and steering to enhance fuel efficiency, driving performance, and safety.

The system dynamics are represented as:

$${x}_{t + 1} = {A}_{m} {x}_{t} + {B}_{m} {u}_{t} + {d}_{m} ,$$

where xₜ includes the vehicle's state (e.g., speed, engine RPM, and gear), and uₜ represents inputs like throttle position or braking force. Constraints such as maximum engine torque or vehicle stability limits are modeled as:

$${A}_{m} {x}_{t} + {B}_{m} {u}_{t} \leq {c}_{m} .$$

Iterative weak relaxation refines weak formulations of the MIP problem to ensure feasible solutions for discrete and continuous dynamics. For example, during gear transitions, cutting planes such as:

$${a}_{t}^{⊤} {x}_{t} + {b}_{t}^{⊤} {u}_{t} \leq {d}_{t} ,$$

tighten the relaxation, ensuring smooth shifts and fuel-efficient trajectories. This iterative refinement enables the optimization of hybrid automotive dynamics while respecting physical constraints.

### Industrial Process Control Systems

Some embodiments are integrated with industrial process control systems 940, where the PWA framework models discrete operational modes (e.g., switching machinery states or production stages) and continuous control variables, including flow rates, temperatures, and pressures. The MIP problem optimizes operational efficiency and productivity while ensuring compliance with safety constraints.

The dynamics are described as:

$${x}_{t + 1} = {A}_{m} {x}_{t} + {B}_{m} {u}_{t} + {d}_{m} ,$$

where xₜ represents process states (e.g., temperatures or pressures), and uₜ represents control variables (e.g., valve positions or flow rates). Physical constraints, such as maximum pressure or temperature limits, are expressed as:

$${A}_{m} {x}_{t} + {B}_{m} {u}_{t} \leq {c}_{m} .$$

Iterative weak relaxation iteratively improves the feasibility of the MIP solution. Violations, such as exceeding temperature thresholds during mode transitions, are addressed by generating cuts:

$${a}_{t}^{⊤} {x}_{t} + {b}_{t}^{⊤} {u}_{t} \leq {d}_{t} .$$

This ensures the process adheres to safety and operational constraints while optimizing productivity. For example, during a chemical reaction, the method ensures that transitions between heating and cooling stages maintain product quality without exceeding pressure or temperature limits.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the disclosure is not limited to the specific embodiments described above, but only by the claims and their equivalents.

1. A method for controlling a piecewise affine (PWA) system having discrete state transitions by solving a mixed-integer programming (MIP) problem that couples discrete choices of modes of operation the PWA system or regions of state space of the PWA system with continuous control decisions over a time horizon, comprising:
solving a relaxation of the MIP problem that considers a temporal evolution of states and controls of the PWA system across a sequence of time steps in the time horizon to produce a solution defining a sequence of control commands transitioning a sequence of states of the PWA system within the time horizon;
comparing the solution with a sequence of convex hull formulations determined for different subsequences of consecutive time steps, each of the convex hull formulations is determined for a subsequence of consecutive time steps with the time horizon independently from other convex hull formulations in the sequence of convex hull formulations, wherein each of the convex hull formulations captures the tightest feasible region of state space defined by convex hull constraints at a corresponding subsequence of the time steps;
detecting violations in the solution of the relaxation of the MIP problem when the solution over a subsequence of consecutive time steps violates the convex hull formulation for that subsequence of consecutive time steps;
refining the relaxation of the MIP problem by adding inequalities that cut off the detected violations;
resolving the refined relaxation to refine the solution; and
controlling the PWA system with a control command determined based on the solution of the refined relaxation that does not violate the convex hull formulations.

2. The method of claim 1, wherein the convex hull formulation over the subsequence of consecutive time steps is determined using polyhedral constraints of the system at the subsequence of consecutive time steps and is independent of constraints at other time steps.

3. The method of claim 1, wherein the relaxation of the MIP problem is a linear relaxation, and wherein the detecting violations comprises:
solving the linear relaxation of the MIP problem; and
identifying whether the solution lies outside convex hull constraints defined by the convex hull formulation over the subsequence of consecutive time steps.

4. The method of claim 3, wherein refining the relaxation further comprises:
introducing cutting-plane inequalities derived from the violated convex hull constraints sequences; and
ensuring that the added inequalities exclude only invalid solutions while maintaining the feasibility of the MIP problem.

5. The method of claim 3, wherein the convex hull constraints are used as a diagnostic tool to selectively refine the relaxation only for the time steps where violations occur.

6. The method of claim 1, wherein resolving the refined relaxation is performed iteratively until no violations are detected.

7. The method of claim 1, wherein the violation of the convex hull formulations and identification of an inequality that refines the relaxation for convex hull formulation is determined using a cut-generating linear program (CGLP) that operates independently of other the subsequences of consecutive time steps.

8. The method of claim 1, wherein each of the subsequences of consecutive time steps include only two consecutive time steps, while the time horizon includes multiple of such subsequences of consecutive time steps.

9. The method of claim 1, wherein at least some of the subsequences of consecutive time steps include only three or less consecutive time steps, while the time horizon includes multiple of such subsequences of consecutive time steps.

10. The method of claim 1, wherein the MIP problem represents an optimal control problem for a PWA system, and the relaxation incorporates dynamics linking states and controls across consecutive time steps.

11. The method of claim 1, wherein the PWA system represents a robotic system, and the MIP problem models the control of discrete transitions between modes of operation of the robotic system defined by one or a combination of contact, free motion, or manipulation tasks, while optimizing continuous control inputs to achieve a desired trajectory.

12. The method of claim 1, wherein the PWA system represents an energy management system, and the MIP problem optimizes energy consumption and operational efficiency by controlling discrete switching of energy sources or storage systems and continuous adjustments of energy flow across the time horizon.

13. The method of claim 1, wherein the PWA system represents an automotive control system, and the MIP problem optimizes discrete gear shifts, drive modes, or powertrain configurations while managing continuous control inputs including throttle, braking, or steering to enhance fuel efficiency and driving performance.

14. The method of claim 1, wherein the PWA system represents an industrial process control system, and the MIP problem optimizes discrete operational modes of machinery or production stages and continuous control variables including one or a combination of flow rates, temperatures, or pressures variables to maximize productivity and ensure compliance with safety constraints.

15. The method of claim 1, wherein the MIP problem includes safety constraints specific to a domain of the PWA system, including collision avoidance for robotic systems, grid stability for energy management systems, traction control for automotive systems, or fault detection in industrial process control.

16. The method of claim 1, wherein an objective function of the MIP problem is tailored to domain-specific performance metrics, such as minimizing energy consumption in energy systems, maximizing throughput in industrial processes, ensuring smooth gear transitions in automotive systems, or minimizing trajectory tracking errors in robotic systems.

17. A control system for controlling a piecewise affine (PWA) system having discrete state transitions and continuous control dynamics, the control system comprising: a processor configured to execute instructions for solving a mixed-integer programming (MIP) problem that couples discrete mode selections of the PWA system with continuous control decisions over a time horizon; and a memory storing instructions that, when executed by the processor, cause the control system to:
solve a relaxation of the MIP problem that considers a temporal evolution of states and controls of the PWA system across a sequence of time steps in the time horizon to generate a solution defining a sequence of control commands transitioning a sequence of states of the PWA system within the time horizon;
compare the solution with a sequence of convex hull formulations determined for different subsequences of consecutive time steps, each of the convex hull formulations capturing the tightest feasible region of state space at a corresponding subsequence of the time steps;
detect violations in the solution of the relaxation of the MIP problem when the solution over a subsequence of consecutive time steps violates the convex hull formulation for that subsequence;
refine the relaxation of the MIP problem by adding inequalities that cut off the detected violations;
resolve the refined relaxation to refine the solution; and
generate a control command for operating the PWA system based on the solution of the refined relaxation that does not violate the convex hull formulations.

18. The control system of claim 17, wherein the PWA system represents a robotic system, and the processor is further configured to control discrete transitions between modes of operation of the robotic system, the modes including at least one of: free motion, contact-based manipulation, or object gripping, while optimizing continuous control inputs to achieve a desired trajectory.

19. The control system of claim 17, wherein the PWA system represents an energy management system, and the processor is further configured to optimize energy consumption and operational efficiency by controlling discrete switching of energy sources or storage systems and continuous adjustments of energy flow across the time horizon.

20. The control system of claim 17, wherein the PWA system represents an automotive control system, and the processor is further configured to optimize discrete control decisions including gear shifts, drive modes, or powertrain configurations while managing continuous control inputs including throttle, braking, or steering to enhance fuel efficiency and driving performance.
